(19) United States
(12) Patent Application Publication
(10) Pub. No.: US 2016/0248569 A1
(43) Pub. Date: Aug. 25, 2016

(54) Block Acknowledgements for Multiple Devices in High Efficiency Wireless Networks

(71) Applicant: Intel Corporation, Santa Clara, CA (US)

(72) Inventor: Chittabrata Ghosh, Fremont, CA (US)

(21) Appl. No.: 14/734,057

(22) Filed: Jun. 9, 2015

Related U.S. Application Data
(60) Provisional application No. 62/118,836, filed on Feb. 20, 2015.

(51) Int. Cl. H04L 5/00; H04L 1/16

(52) U.S. Cl. CPC H04L 5/0055; H04L 1/1614; H04L 1/165; H04L 1/1621

(57) ABSTRACT

Embodiments herein relate to, among other things, systems, methods, and computer-readable media for a block acknowledgement (BA) frame for multiple communication stations (STAs) having multiple traffic identifiers (TIDs). The BA frame may include BA indications for STAs in each 20 MHz within an 80 MHz PPDU or a 160 MHz PPDU. The BA frame may include a variable size BA bitmap and a BA Ending Sequence Number (ESN) that determines the size of the variable size BA bitmap.

### PRIORITY CLAIM

This application claims priority to U.S. Provisional Patent Application No. 62/118,836 filed on Feb. 20, 2015, entitled “Block Acknowledgements for Multiple Devices in High Efficiency Wireless Networks,” the disclosure of which is hereby incorporated by reference in its entirety.

### BACKGROUND

User devices, such as cell phones, laptops, tablets, set top boxes, and the like are increasingly equipped with wireless communication technologies. Such devices are capable of transmitting and receiving wireless communications at increased capacities and may utilize high efficiency wireless networks, such as WLAN, Institute of Electrical and Electronics Engineers (IEEE) 802.11ax or High-Efficiency WLAN (HEW). The efficient allocation and indication of channels used by such devices may present numerous challenges.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram illustrating an example network environment that may use the block acknowledgement frames described herein, in accordance with an example embodiment of the disclosure;

FIG. 2 is a schematic diagram of a block acknowledgement (BA) frame in accordance with an example embodiment of the disclosure;

FIG. 3 is a schematic diagram BA control field format in a BA frame in accordance with an example embodiment of the disclosure;

FIGS. 4A and 4B are schematic diagrams of a BA Information field format in a BA frame in accordance with an example embodiment of the disclosure;

FIG. 5 is a block diagram of a process for using a multi-STA multi-TID BA frame in accordance with an example embodiment of the disclosure;

FIG. 6 is a functional diagram of an exemplary communication station according to an embodiment of the technique; and

FIG. 7 is a block diagram of an example of a machine upon which, any of one or more techniques (e.g., methods) discussed herein may be performed.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Example embodiments described herein provide certain systems, methods, and devices, for providing signaling information to Wi-Fi devices in various Wi-Fi networks, including, but not limited to, IEEE 802.11ax. Embodiments herein relate to, among other things, a Block Acknowledgement (also referred to as “Block ACK” or “BA”) frame for multiple communication stations (STAs) having multiple traffic identifiers (TIDs). The BA frame may include BA indications for STAs in multiple channels and may include a variable length BA Bitmap. For example, the BA frame may include a BA indication for STAs in each 20 MHz within an 80 MHz PPDU or a 160 MHz PPDU. The BA frame may also include a BA Ending Sequence Number and a variable size BA Bitmap having a size defined by a BA Starting Sequence Control and the BA Ending Sequence Number.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims

The word “exemplary” is used herein to mean “serving as an example, instance, or illustration.” Any embodiment described herein as “exemplary” is not necessarily to be construed as preferred or advantageous over other embodiments. The terms “computing device”, “communication station”, “station” (also referred to as STA), “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, access terminal, or other personal communication system (PCS) device. The device may be either mobile or stationary

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit

The term “access point” (AP) as used herein may be a fixed station. An access point may also be referred to as an access node, a base station or some other similar terminology known in the art. An access terminal may also be called a mobile station, a user equipment (UE), a wireless communication device or some other similar terminology known in the art. Embodiments disclosed herein generally pertain to wireless networks. Some embodiments can relate to wireless networks that operate in accordance with one of the IEEE 802.11 standards including the IEEE 802.11ax standard

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like

Some embodiments may be used in conjunction with one or more types of wireless communication signals and/or systems following one or more wireless communication protocols, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

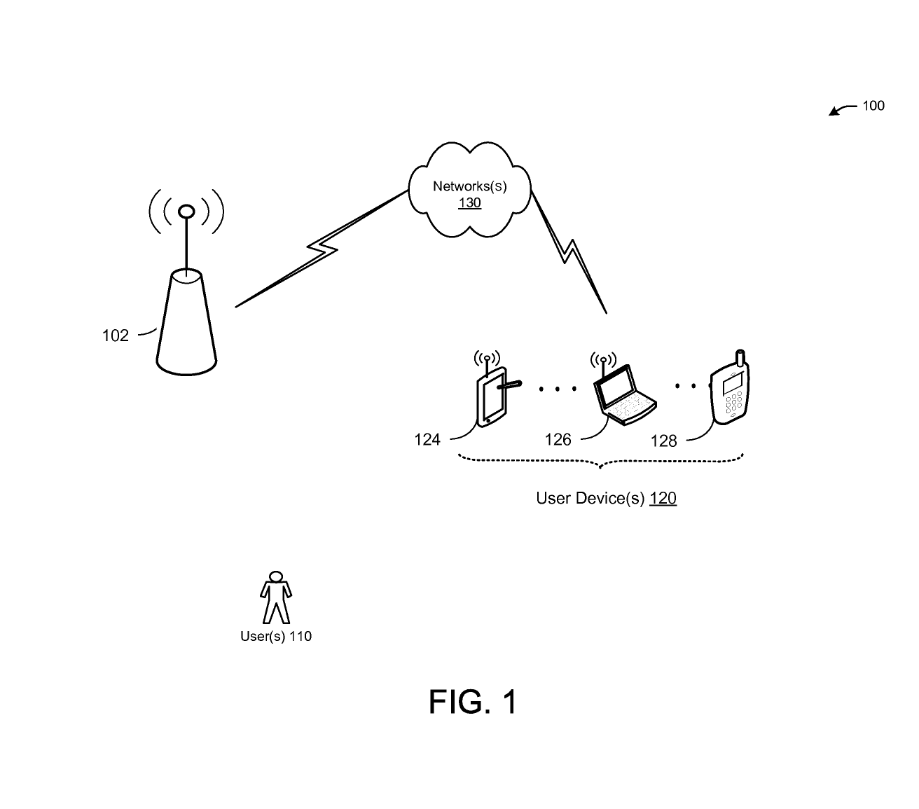

FIG. 1 is a network diagram illustrating an example network environment, according to some example embodiments of the present disclosure. Wireless network 100 can include one or more computing devices 120 and one or more access point(s) (AP) 102, which may communicate in accordance with IEEE 802.11 communication standards, including IEEE 802.11ax. The computing device(s) 120 may be mobile devices that are non-stationary and do not have fixed locations. The one or more APs 102 may be stationary and have fixed locations.

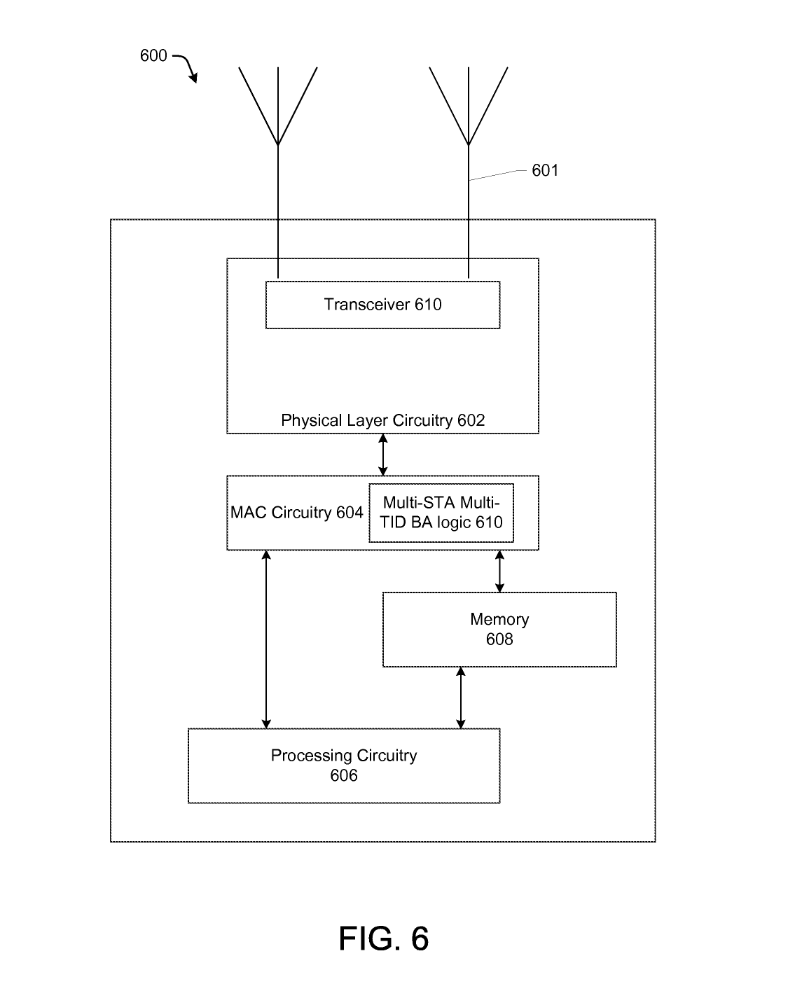

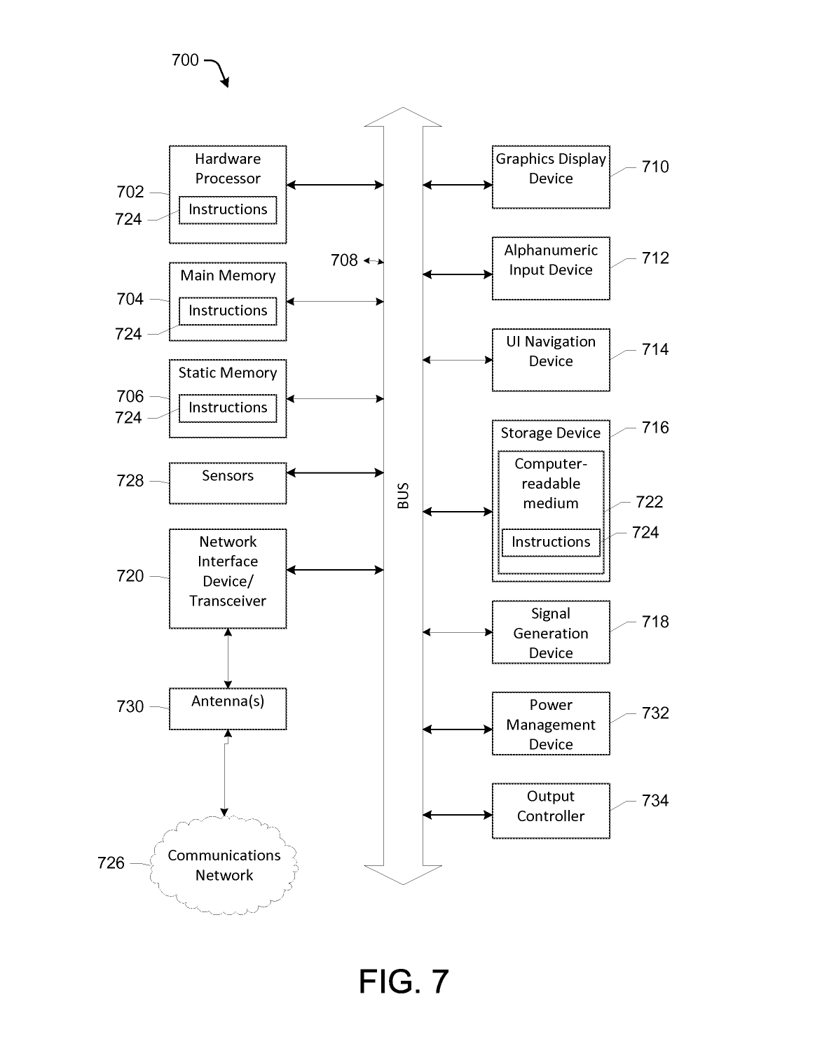

In some embodiments, the user devices 120 and AP 102 can include one or more computer systems similar to that of the functional diagram of FIG. 6 and/or the example machine/system of FIG. 7.

In accordance with some IEEE 802.11ax (High-Efficiency WLAN (HEW)) embodiments, an access point may operate as a master station which may be arranged to contend for a wireless medium (e.g., during a contention period) to receive exclusive control of the medium for an HEW control period. The master station may transmit an HEW master-sync transmission at the beginning of the HEW control period. During the HEW control period, HEW stations may communicate with the master station in accordance with a non-contention based multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique. In other embodiments, the multiple access technique may be a time-division multiple access (TDMA) technique or a frequency division multiple access (FDMA) technique. In certain embodiments, the multiple access technique may be a space-division multiple access (SDMA) technique

The master station may also communicate with legacy stations in accordance with legacy IEEE 802.11 communication techniques. In some embodiments, the master station may also be configurable to communicate with HEW stations outside the HEW control period in accordance with legacy IEEE 802.11 communication techniques, although this is not a requirement.

One or more illustrative user device(s) 120 may be operable by one or more users 110. The user device(s) 120 may include any suitable processor-driven user device including, but not limited to, a desktop computing device, a laptop computing device, a server, a router, a switch, a smartphone, a tablet, wearable wireless device (e.g., bracelet, watch, glasses, ring, etc.) and so forth.

Any of the user device(s) 120 (e.g., user devices 124, 126, 128), and AP 102 may be configured to communicate with each other via one or more communications networks 130 wirelessly or wired. Any of the communications networks 130 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, IEEE 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the IEEE 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

The wireless network 130 may enable allocation of sub-channels to user devices 120 via, for example, OFDMA. In some embodiments, a scheduling message such as a Trigger frame (TF) from the AP 102 may indicate that a user device ID, assigned sub-channels, and duration of access. In some embodiments, the Trigger frame may be used to synchronize user devices 120 (sometimes referred to as “STAs”) prior to their uplink (UL) traffic transmission. The designated STAs with assigned resources (e.g., channels or sub-channels) indicated in the Trigger frame may transmit their UL data after a short interframe space (SIFS) time of Trigger frame transmission. Following the UL traffic after SIFS time, a control frame may be sent by the AP 102 that acknowledges the UL data using a Block Acknowledgement (also referred to as “Block ACK” or “BA”) frame. As described further below, the Block ACK (BA) frame transmitted by the AP 102 to multiple STAs may be compressed according to the techniques described herein.

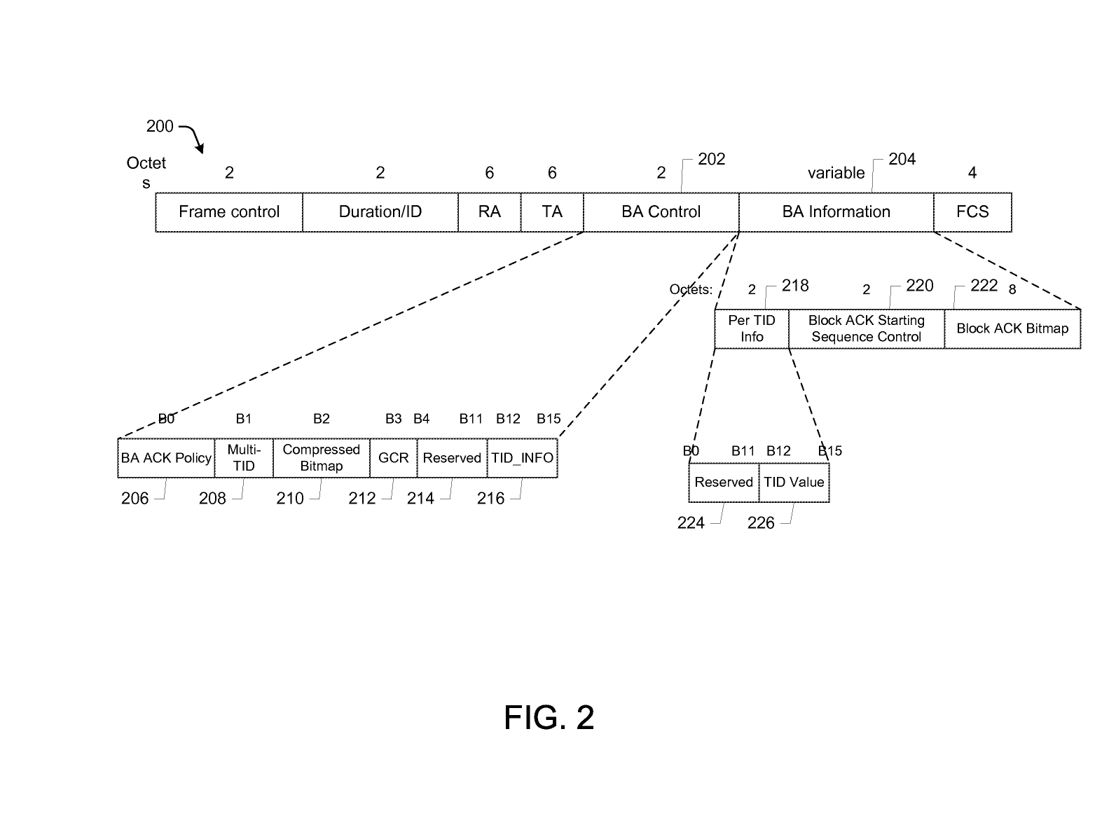

FIG. 2 depicts a schematic diagram of a Block Acknowledgment (BA) frame 200 having multi-STA and multi-TID BA indications and a variable size BA Bitmap in accordance with an example embodiment of the disclosure. As shown in FIG. 2, the BA frame 200 may include a BA Control field 202 (e.g., having 2 octets) and a BA Information field 204 (e.g., having a variable size). It should be appreciated that other embodiments may include a BA frame having multi-STA and multi-TID BA indications and a variable size BA Bitmap with different arrangements and numbers of fields.

FIG. 2 also depicts the subfields of the BA Control field 202 and the BA Information field 204. For example, the BA Control field 202 may include the following subfields: BA ACK Policy 206 (e.g., having one bit B0), Multi-traffic identifier (Multi-TID) 208 (having one bit B1), Compressed Bitmap 210 (e.g., having one bit B2), Groupcast with Retries (GCR) 212 (having one bit B3), Reserved bits 214 (e.g., having eight bits B4-B11), and TID_INFO 216 (e.g., having four bits B12-B15.

FIG. 2 depicts the subfields of the BA Information field 204. For example, for each TID, the BA Information field 204 may include the following subfields: Per TID Info 218 (e.g., having two octets), Block ACK Starting Sequence Control 220 (e.g., having two octets), and BA Bitmap 222 (e.g., having eight octets). Additionally, FIG. 2 depicts subfields of the Per TID Info subfield 218 which may include Reserved bits 224 (e.g., having 12 bits B0-B11) and TID Value 226 (e.g., having four bits B12-B15).

Some proposals may use the Reserved bits 224 within the Per TID info subfield 218 to define an association identification (AID). However, as the BA frame is transmitted after the Trigger frame and UL traffic, the AID information is available from the previously received Trigger frame and may be implicitly derived. Thus, the 11 bits of the Reserved bits 224 may be used for the definition of a BA Ending Sequence Number (ESN) as described further below. Other proposals may use one of the bits in the Reserved bits 214 of the BA Control field 202 to define an All ACK Indication. In such instances, the All ACK Indication bit may be set to 1 to indicate that BA Information is not present. However, in such instances there is unlikely to be a BA (i.e., an AP has received all UL data successfully from all STAs) for all received packets due to packet error rates that may approach up to 10%. Thus, the All ACK Indication may be of minimal to no use.

In contrast to the above proposals, described further below is a BA frame for multiple STAs and multiple TIDs. The BA frame includes a BA for STAs assigned to each 20 MHz channel using the Reserved bits 214 of the BA Control field 202. Additionally, a BA Ending Sequence Number and BA/ACK may be provided using the Reserved bits 24 of the Per TID Info subfield 218.

In some embodiments, the BA described herein may be referred to as a “multi-STA multi-TID BA.” In some embodiments, the multi-STA multi-TID BA may be indicated by setting the Multi-TID subfield 208 to 1, the Compressed Bitmap subfield 210 to 1, and the GCR subfield 212 to 1. For example, Table 1 below illustrates BA frame variants indicated using combinations of the Multi-TID subfield 208, the Compressed Bitmap subfield 210, and the GCR subfield 212:

| Multi-TID | Compressed | | |
|---|---|---|---|
| subfield | Bitmap | | Block ACK (BA) |
| value | subfield value | GCR subfield value | frame variant |
| 0 | 0 | 0 | Basic Block ACK |
| 0 | 1 | 0 | Compressed BA |
| 1 | 0 | 0 | Extended Compressed |
| | | | BA |
| 1 | 1 | 0 | Multi-TID BA |
| 0 | 0 | 1 | Reserved |
| 0 | 1 | 1 | GCR BA |
| 1 | 0 | 1 | Reserved |
| 1 | 1 | 1 | Multi-STA Multi-TID |
| | | | BA |

Thus, as shown above, different types of BA frames, including the BA frame having the multi-STA multi-TID BA described herein, may be indicated using the Multi-TID subfield 208, the Compressed Bitmap subfield 210, and the GCR subfield 212.

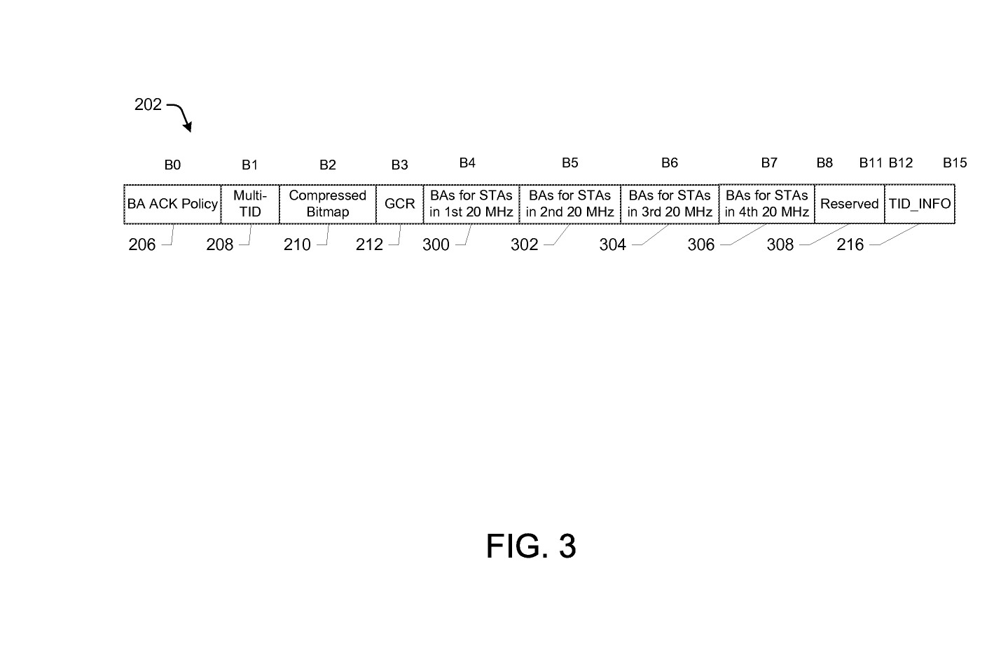

FIG. 3 depicts the BA control field 202 format in a BA frame for defining a BA for multiple STAs and multiple TIDs in accordance with an example embodiment of the disclosure. As shown in FIG. 3, bits of the previously Reserved bits 214 of the BA Control field 202 may be used to indicate BA for STAs assigned to every 20 MHz channel. In some embodiments, four reserved bits may be used for 80 MHz PLCP Protocol Data Unit (PPDU) to indicate BA for STAs assigned to every 20 MHz. In some embodiments, eight reserved bits may be used for 160 MHz PPDU to indicate BA for STAs assigned to every 20 MHz.

FIG. 3 depicts an example embodiment having four bits to indicate BA for STAs assigned to every 20 MHz. For example, as shown in FIG. 3, the BA Control field 202 may include the following subfields (using some of the previously Reserved bits 214): subfield 300 for BAs for STAs in 1st 20 MHz, subfield 302 for BAs for STAs in 2nd 20 MHz, subfield 304 for BAs for STAs in 3rd 20 MHz, and subfield 306 for BAs for STAs in 4^{th} 20 MHz. A subfield of four Reserved bits 308 may remain. As noted above, in some embodiments the additional four Reserved bits 308 may be used to indicate BAs for STAs assigned the additional 20 MHz channels of a 160 MHz transmission bandwidth.

The BAs for STAs are ordered in the BA Control field 202 in the same order as indicated in the Trigger frame; thus, AID indication of an STA is not required, as the STA or STAs are aware of the 20 MHz bandwidth that they have been assigned by the AP as indicated in the Trigger frame. For embodiments in which multiple STAs are assigned within a 20 MHz bandwidth (e.g., with OFDMA transmission of 26 tones or its multiples which may also be referred to as “sub-channels”), the value in the subfield 300, 302, 304, or 306 indicates BA for all STAs together. For example, in some embodiments up to 9 STAs may be assigned sub-channels within a 20 MHz bandwidth. If the bit in a respective subfield 300, 302, 304, or 306 is set to 1, the indication indicates that the AP has received packets from all or any one of the STAs with narrow bandwidth transmissions. For example, if multiple STAs are assigned sub-channels in the 1st 20 MHz and the bit in subfield 300 is set to 1, this indication indicates that the AP has received packets from all or any one of the multiple STAs. If the bit in a respective subfield 300, 302, 304, or 306 is set to 0, the indication implies that the AP may not have correctly received packets from any one of the multiple STAs assigned to that 20 MHz bandwidth. The BA may be repeated in order beginning with the first STA.

As will be appreciated, the subfields 300, 302, 304, and 306 may all be set to 1 to provide an All ACK indicator similar to that discussed above in alternative proposals. For instance, if each of the subfields 300, 302, 304, and 306 is set to 1, this indicates that the AP has received packets from STAs in all four of the 20 MHz allocations of an 80 MHz PPDU.

In some embodiments, if an STA is assigned 40 MHz bandwidth spanning two of the subfields 300, 302, 304, or 306 in the BA Control field 202, the final bit value in the subfield is considered and the bit value in the preceding 20 MHz bandwidth is ignored. For example, if an STA is assigned 1st and 2nd 20 MHz bandwidths, the AP sets the bit value in the subfield 302 for BAs for STAs in 2nd 20 MHz and the bit value in the subfield 300 for BAs for STAs in 1st 20 MHz may be ignored.

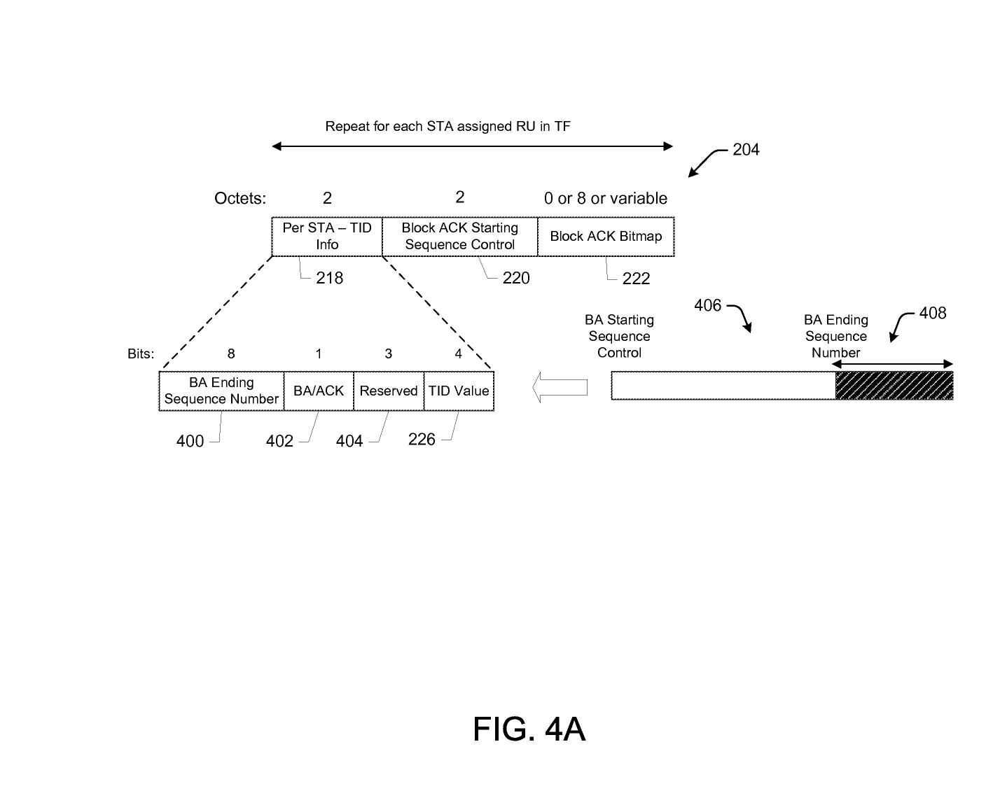

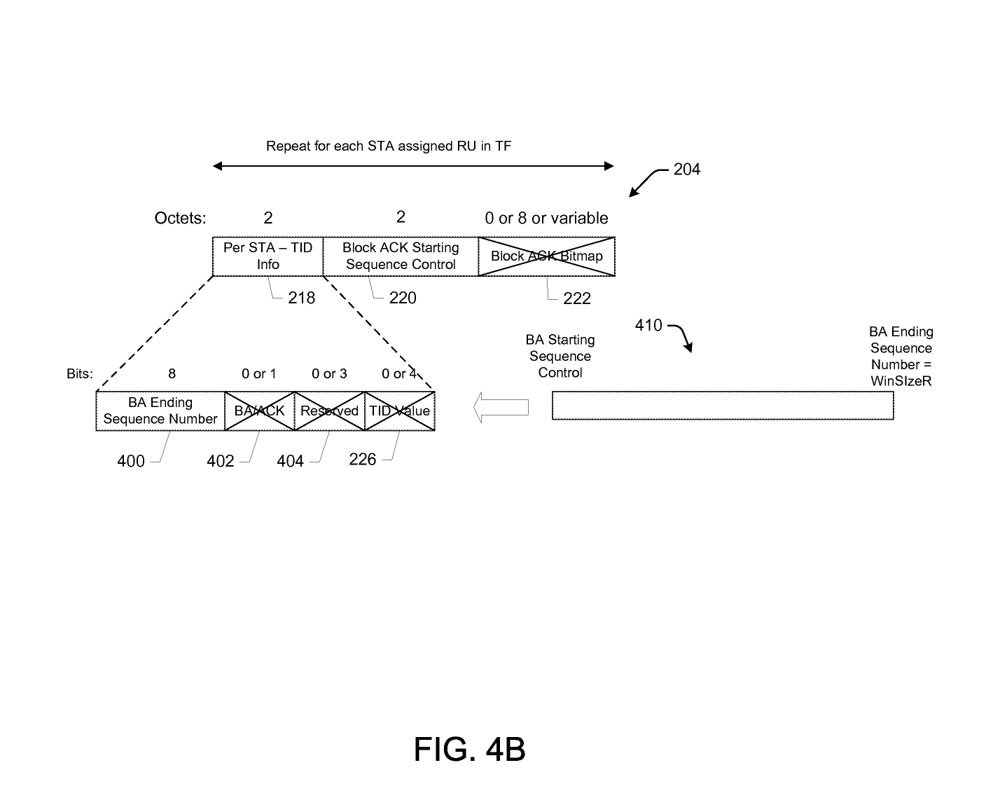

FIGS. 4A and 4B depict the BA Information field 204 format in a BA frame for defining a variable size BA Bitmap in accordance with an example embodiment of the disclosure. As noted above and as shown in FIGS. 4A and 4B, the BA Information subfields 218, 220, and 222 may be repeated for each STA assigned RU in a Trigger frame.

As shown in FIGS. 4A and 4B, bits of the previously Reserved bits 224 of the BA Information field 204 may be used to indicate a BA Ending Sequence Number and a BA/ACK. In some embodiments, nine reserved bits may be used. For example, as shown in FIG. 4A, the BA Information field 204 may include a BA Ending Sequence Number subfield 400 (e.g., having eight bits) and a BA/ACK subfield 402 (e.g., having one bit). Additionally, three Reserved bits 404 may remain in the Per STA-TID Info subfield 218. Block 406 in FIG. 4A indicates the total number of MPDUs or A-MPDUs indicated by the variable BA Ending Sequence Number (and beginning with the BA Starting Sequence Control).

The BA Ending Sequence Number subfield 400 indicates the BA Ending Sequence Number (ESN). The BA Ending Sequence Number is the end value of a sequence of MAC Protocol Data Units (MPDUs) or Aggregated MAC Protocol Data Units (A-MPDU) that that AP intends to Block Acknowledge and may define the size of the BA bitmap. The size of the BA bitmap may be determined by comparison of the BA Ending Sequence Number and “WinSizeR.” WinSizeR may refer to the maximum transmission window size (i.e., the total number of octets transmitted starting from the BA SSC). If the value indicated in the BA Ending Sequence Number subfield 400 is equal to WinSizeR, this implies the BAs are intended for the entire sequence of MPDUs or A-MPDUs starting from the value indicated in the Block ACK Starting Sequence Control (SSC) subfield 220. In such instances, the indication of the total number of MPDUs or A-MPDUs that were correctly received assists the STA in indicating whether the AP has received all its intended packets. In contrast, if the value indicated in the BA Ending Sequence Number subfield 400 is not equal to WinSizeR, the size of the BA Bitmap is equal to WinSizeR minus the value in the BA Ending Sequence Number subfield 400+one (i.e., WinSizeR−BA ESN+1).

As shown in FIG. 4A, for example, the BA Bitmap may have a variable size indicated by BA Ending Sequence Number, such that the BA Bitmap may be smaller than the total available size. The shaded region 408 of FIG. 4A indicates the size of the BA Bitmap that is omitted when the BA Ending Sequence Number defines a smaller variable size Black ACK bitmap (and when the BA Ending Sequence Number is less than WinSizeR). For example, in embodiments in which the total available size of a BA Bitmap is 64 bits, the BA Bitmap may be reduced to less than 64 bits, e.g., 8 bits, 16 bits, or 32 bits, and so on. In one such example, the size of the BA Bitmap indicated by region 408 may be 32 bits. In this manner, the BA Bitmap may be reduced to compress the size of the BA frame.

FIG. 4B depicts a BA Information field format in a BA frame for defining a variable size BA Bitmap when the BA Ending Sequence Number equals WinSizeR in accordance with an example embodiment of the disclosure. As shown in FIG. 4B, if the BA Ending Sequence Number value indicated in subfield 400 equals WinSizeR, only the Block ACK SSC subfield 220 is included and the BA Bitmap may not be used. For example, as shown in FIG. 4B, the block 410 that indicates the total number of MPDUs or A-MPDUs indicated by the variable BA Ending Sequence Number (and beginning with the BA Starting Sequence Control) is equal to WinSizeR, the total number of octets transmitted starting from the BA Starting Sequence Control. In such instances, the BA sent from the AP is intended to acknowledge all the packets sent from the STA. Additionally, the BA/ACK subfield 402, the Reserved bits 406, and the TID Value 226 may not be used.

In some embodiments, setting the value indicated in the BA Ending Sequence Number subfield 400 to 0 may imply that the entire BA Bitmap is included. For example, in such instances the entire BA Bitmap may have values of 0 to indicate that none of the packets sent from the STA are being acknowledged.

In addition to embodiments having an access point and communication stations in, for example, HEW, the BA frame discussed above may be implemented in peer-to-peer networks, such as for machine-to-machine communications (M2M) used in an “Internet of Things” (IOT). In such embodiments, a communication station may receive packets from other stations and may itself send a multi-TID multi-STA frame in accordance with the techniques described above. In such embodiments, logic (e.g., implemented in software modules, hardware, or both) for receiving and transmitting the multi-TID multi-STA block acknowledgement may be implemented on each communication station (e.g., each device of an IOT network).

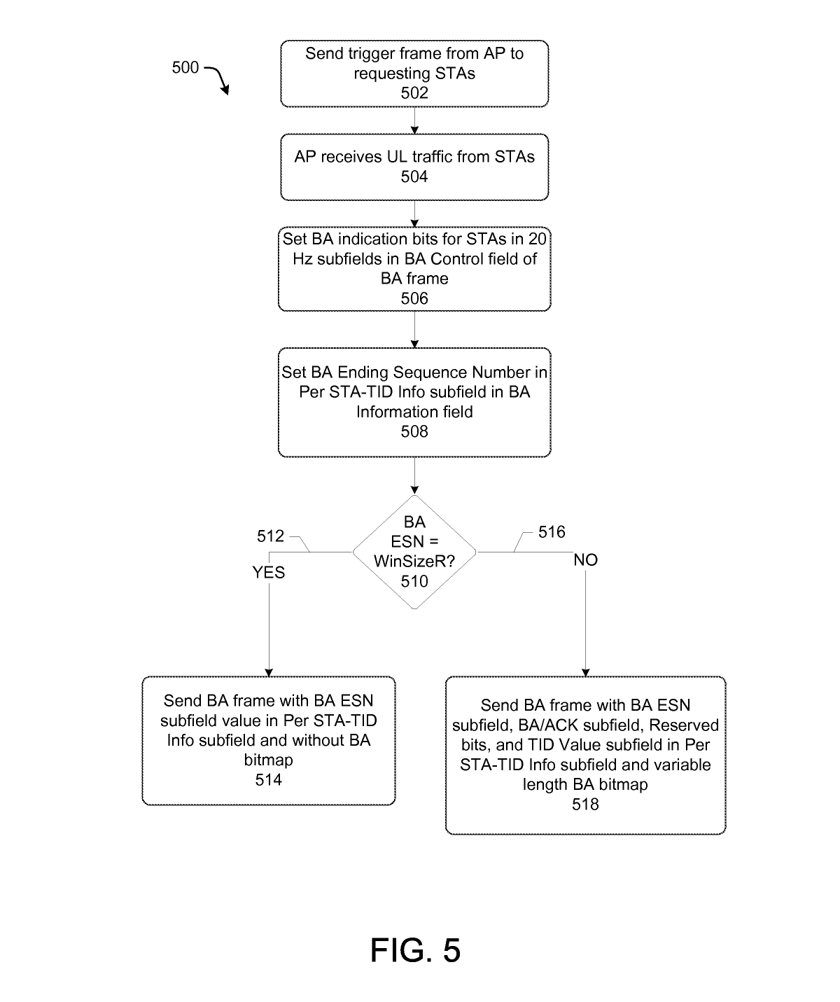

FIG. 5 depicts a process 500 for using a multi-STA multi-TID BA frame in accordance with an example embodiment of the disclosure. In some embodiments, for example, the process 500 may be implemented in computer-executable instructions stored on a computer-readable medium and executed by a processor (e.g., a processor of an AP) or logic executed by circuitry of a processor. Initially, as discussed above, a Trigger frame (TF) may be sent from an AP to requesting STAs (block 502). In response to receiving the Trigger frame, the AP may receive UL traffic from designated STAs with assigned resources indicated in the Trigger frame (block 504).

Next, BA indication bits for every 20 Hz channel may be set in the BA Control field of the multi-STA multi-TID BA frame. For example, as discussed, for STAs in the first 20 MHz, the BA for STAs in 1st 20 MHz subfield may be set to 1 to indicate a BA. As also noted above, the BA indication bits may be set for every 20 MHz within an 80 MHz PPDU or, in some embodiments, for every 20 MHz within a 160 MHz PPDU.

As also noted above, the BA Ending Sequence Number (ESN) may be set in the BA Ending Sequence Number subfield of the Per STA-TID Info subfield in the BA Information field of the of the multi-STA multi-TID BA frame (block 508). As noted above, in some embodiments the BA ESN may be equal to WinSizeR (decision block 510). If the BA ESN equals WinSizeR (line 512), the multi-STA multi-TID BA frame may be sent with a value in the BA Ending Sequence Number subfield of the Per STA-TID Info subfield in the BA Information field (block 514). If the BA ESN does not equal WinSizeR (line 516), the multi-STA multi-TID BA frame may be sent with values in the BA Ending Sequence Number subfield, BA/ACK subfield, Reserved bits (if used), and TID Value subfield (block 518).

In some embodiments, the sending of frames may include or refer to directing the transmission of frames over a wireless network by for example, directing a transceiver or transmitter to transmit the frames over a wireless network (e.g., a channel or sub-channel of a wireless network). In some embodiments, frames may be obtained from a transceiver or receiver that receives frames transmitted over a wireless network (e.g., a channel or sub-channel of a wireless network).

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or user device 120 (FIG. 1) in accordance with some embodiments. The communication station 600 may also be suitable for use as a handheld device, mobile device, cellular telephone, smartphone, tablet, netbook, wireless terminal, laptop computer, femtocell, High Data Rate (HDR) subscriber station, access point, access terminal, or other personal communication system (PCS) device.

The communication station 600 may include physical layer circuitry 602 having a transceiver 610 for transmitting and receiving signals to and from other communication stations using one or more antennas 601 and media access control (MAC) circuitry 604. The communication station 600 may also include processing circuitry 606 and memory 608 arranged to perform the operations described herein. In some embodiments, the physical layer circuitry 602 and the processing circuitry 606 may be configured to perform operations (e.g., set bits, read bits, etc.) detailed in FIGS. 2-5.

In accordance with some embodiments, the MAC circuitry 604 may be arranged to contend fora wireless medium and configure frames or packets for communicating over the wireless medium and the physical layer circuitry 602 may be arranged to transmit and receive signals. In some embodiments, the MAC circuit 604 may include multi-STA multi-TID BA logic 610 to implement the techniques described above. For example, in some embodiments the communication station 600 may be illustrative of an access point (AP) that transmits multi-STA multi-TID BA frames according to the multi-STA multi-TID BA logic 610 that implements the techniques described above. In some embodiments, the multi-STA multi-TID BA logic 610 may be implemented as instructions stored on a computer-readable medium (examples of which are discussed below) of the MAC circuitry 604. In other embodiments, some or all portions of the multi-STA multi-TID BA logic 610 may be implemented in other components of the station 600 (e.g., the physical layer circuitry 602).

The physical layer circuitry 602 may include circuitry for modulation/demodulation, upconversion/downconversion, filtering, amplification, etc. In some embodiments, the processing circuitry 606 of the communication station 600 may include one or more processors. In some embodiments, two or more antennas 601 may be coupled to the physical layer circuitry 602 arranged for sending and receiving signals. The memory 608 may store information for configuring the processing circuitry 606 to perform operations for configuring and transmitting message frames and performing the various operations described herein. The memory 608 may comprise any type of memory, including non-transitory memory, for storing information in a form readable by a machine (e.g., a computer). For example, the memory 608 may comprise a computer-readable storage device may, read-only memory (ROM), random-access memory (RAM), magnetic disk storage media, optical storage media, flash-memory devices and other storage devices and media.

In some embodiments, the communication station 600 may be or be a part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or another device that may receive and/or transmit information wirelessly.

In some embodiments, the communication station 600 may include one or more antennas 601. The antennas 601 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712 and UI navigation device 714 may be a touch screen display. The machine 700 may additionally include a storage device (i.e., drive unit) 716, a signal generation device 718 (e.g., a speaker), a network interface device/transceiver 720 coupled to antenna(s) 730, and one or more sensors 728, such as a global positioning system (GPS) sensor, compass, accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The storage device 716 may include a computer readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute computer readable media.

While the computer readable medium 722 is illustrated as a single medium, the term “computer readable medium” (sometimes referred to as “machine-readable medium”) may include a single medium or multiple media (e.g., a centralized or distributed database, and/or associated caches and servers) configured to store the one or more instructions 724.

The term “computer readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine readable medium with a plurality of particles having resting mass. Specific examples of massed machine-readable media may include: non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 702.11 family of standards known as Wi-Fi®, IEEE 702.16 family of standards known as WiMax®), IEEE 702.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 729. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

### Further Embodiments

In a first example embodiment there is disclosed a non-transitory computer-readable medium storing computer-executable instructions. When executed by a processor, the computer-executable instructions cause the processor to perform operations that include setting, in a first field of a BA frame, a first block acknowledgment (BA) indication associated with a first channel. The BA frame includes the first field for the first block acknowledgment indication associated with the first channel and a second field for a second block acknowledgment indication associated with the second channel. When executed by a processor, the computer-executable instructions further cause the processor to perform operations that include setting, in a BA ending sequence number (ESN) field of the BA frame, a BA ESN determinative of a size of a variable size BA bitmap of the BA frame and directing the transmission, over a wireless network comprising the first channel and the second channel, the block acknowledgement frame from a first computing device.

In some embodiments, the computer-executable instructions further cause the processor to perform operations that include setting a BA starting sequence control (SSC) using a BA SSC field of the block acknowledgment frame, wherein the BA SSC and the BA ending sequence number define the size of the variable size BA bitmap. In some embodiments, the first channel may include a first 20 MHz channel and the second channel may include a second 20 MHz channel allocated after the first 20 MHz channel. In some embodiments, the computer-executable instructions further cause the processor to perform operations that include determining that the BA ESN does not equal a total number of octets transmitted starting from a BA SSC and setting an acknowledgment indication in an acknowledgment field and a traffic identifier (TID) value in a TID field of the BA frame. In some embodiments, the computer-executable instructions further cause the processor to perform operations that include determining that the BA ESN equals a total number of octets transmitted starting from a BA SSC, such that the block acknowledgement frame transmitted from the first computing device does not include a BA bitmap.

In some embodiments, the computer-executable instructions further cause the processor to perform operations that include setting a value in a multi-traffic identifier indication field, a value in a compressed bitmap indication field, and a value in a Groupcast with Retries (GCR) indication field to indicate a type of the block acknowledgement frame. In some embodiments, the BA frame includes a third field for a third block acknowledgment indication for a third channel and a fourth field for a fourth block acknowledgment indication for a fourth channel. In some embodiments, the first channel includes two or more sub-channels and the first block acknowledgement indication includes a block acknowledgement for the two or more sub-channels.

In a second example embodiment there is disclosed a device having one or more processors. The one or more processors include circuitry having logic to set, in a first field of a BA frame, a first block acknowledgment (BA) indication associated with a first channel. The BA frame includes the first field for the first block acknowledgment indication associated with the first channel and a second field for a second block acknowledgment indication associated with the second channel. The one or more processors further include circuitry having logic to set, in a BA ending sequence number (ESN) field of the BA frame, a BA ESN determinative of a size of a variable size BA bitmap of the BA frame and direct the transmission, over a wireless network comprising the first channel and the second channel, of the block acknowledgement frame from a first computing device.

In some embodiments, the one or more processors further include circuitry having logic to set a BA starting sequence control (SSC) using a BA SSC field of the block acknowledgment frame, wherein the BA SSC and the BA ending sequence number define the size of the variable size BA bitmap. In some embodiments, the first channel may include a first 20 MHz channel and the second channel may include a second 20 MHz channel allocated after the first 20 MHz channel. In some embodiments, the one or more processors further include circuitry having logic to determine that the BA ESN does not equal a total number of octets transmitted starting from a BA SSC and setting an acknowledgment indication in an acknowledgment field and a traffic identifier (TID) value in a TID field of the BA frame. In some embodiments, the one or more processors further include circuitry having logic to determine that the BA ESN equals a total number of octets transmitted starting from a BA SSC, such that the block acknowledgement frame transmitted from the first computing device does not include a BA bitmap.

In some embodiments, the one or more processors further include circuitry having logic to set a value in a multi-traffic identifier indication field, a value in a compressed bitmap indication field, and a value in a Groupcast with Retries (GCR) indication field to indicate a type of the block acknowledgement frame. In some embodiments, the BA frame includes a third field for a third block acknowledgment indication for a third channel and a fourth field for a fourth block acknowledgment indication for a fourth channel. In some embodiments, the first channel includes two or more sub-channels and the first block acknowledgement indication includes a block acknowledgement for the two or more sub-channels.

In a third example embodiment there is disclosed a device having one or more processors. The one or more processors include circuitry having logic to obtain first frames transmitted over a first channel of a wireless network and generate, in response to obtaining the first frames, a block acknowledgement (BA) frame. The BA frame includes a first BA indication associated with the first channel and a second BA frame associated with a second channel of the wireless network. The one or more processors further include circuitry having logic to direct the transmission, over a wireless network, of the BA frame from the device.

In some embodiments, the BA frame includes a variable size BA bitmap. In some embodiments, the BA frame includes a BA ending sequence number (ESN) determinative of a size of the variable size BA bitmap. In some embodiments, the BA frame includes a BA starting sequence control (SSC), wherein the BA SSC and the BA ESN define the size of the variable size BA bitmap. In some embodiments, generating the BA frame includes determining whether the BA ESN is equal to a number of octets transmitted from the device beginning with the BA SSC. In some embodiments, the BA frame includes a third BA indication associated with a third channel of the wireless network and a fourth BA indication associated with a fourth channel of the wireless network.

In a fourth example embodiment there is disclosed a method that includes setting, in a first field of a BA frame, a first block acknowledgment (BA) indication associated with a first channel. The BA frame includes the first field for the first block acknowledgment indication associated with the first channel and a second field for a second block acknowledgment indication associated with the second channel. The method further includes setting, in a BA ending sequence number (ESN) field of the BA frame, a BA ESN determinative of a size of a variable size BA bitmap of the BA frame and directing the transmission, over a wireless network comprising the first channel and the second channel, of the block acknowledgement frame from a first computing device.

In some embodiments, the method further includes setting a BA starting sequence control (SSC) using a BA SSC field of the block acknowledgment frame, wherein the BA SSC and the BA ending sequence number define the size of the variable size BA bitmap. In some embodiments, the first channel may include a first 20 MHz channel and the second channel may include a second 20 MHz channel allocated after the first 20 MHz channel. In some embodiments, the method further includes determining that the BA ESN does not equal a total number of octets transmitted starting from a BA SSC and setting an acknowledgment indication in an acknowledgment field and a traffic identifier (TID) value in a TID field of the BA frame. In some embodiments, the method further includes determining that the BA ESN equals a total number of octets transmitted starting from a BA SSC, such that the block acknowledgement frame transmitted from the first computing device does not include a BA bitmap.

In some embodiments, the method further includes setting a value in a multi-traffic identifier indication field, a value in a compressed bitmap indication field, and a value in a Groupcast with Retries (GCR) indication field to indicate a type of the block acknowledgement frame. In some embodiments, the BA frame includes a third field for a third block acknowledgment indication for a third channel and a fourth field for a fourth block acknowledgment indication for a fourth channel. In some embodiments, the first channel includes two or more sub-channels and the first block acknowledgement indication includes a block acknowledgement for the two or more sub-channels.

In a fifth example embodiment there is disclosed a non-transitory computer-readable medium storing computer-executable instructions. When executed by a processor, the computer-executable instruction cause the processor to perform operations that include obtaining first frames transmitted over a first channel of a wireless network and generate, in response to obtaining the first frames, a block acknowledgement (BA) frame. The BA frame includes a first BA indication associated with the first channel and a second BA frame associated with a second channel of the wireless network. When executed by a processor, the computer-executable instruction further cause the processor to perform operations that include directing the transmission, over a wireless network, the BA frame from the device.

In some embodiments, the BA frame includes a variable size BA bitmap. In some embodiments, the BA frame includes a BA ending sequence number (ESN) determinative of a size of the variable size BA bitmap. In some embodiments, the BA frame includes a BA starting sequence control (SSC), wherein the BA SSC and the BA ESN define the size of the variable size BA bitmap. In some embodiments, generating the BA frame includes determining whether the BA ESN is equal to a number of octets transmitted from the device beginning with the BA SSC. In some embodiments, the BA frame includes a third BA indication associated with a third channel of the wireless network and a fourth BA indication associated with a fourth channel of the wireless network.

In a sixth example embodiment there is disclosed a system having a wireless access point, a first device configured to transmit, over a first channel of a wireless network, first frames to the wireless access point, and a second device configured to transmit, over a second channel of the wireless network, second frames to the wireless access point. The wireless access point includes one or more processors having circuitry including logic to obtain the first frames over the first channel of the wireless network and obtain the second frames transmitted over the second channel of the wireless network. The one or more processors have circuitry further including logic to generate a block acknowledgement (BA) frame. The BA frame includes a first BA indication associated with the first channel and a second BA indication associated with the second channel. In some embodiments, the one or more processors have circuitry further including logic to direct the transmission, over a wireless network, the BA frame to at least one of the first device and the second device.

In some embodiments, the BA frame includes a variable size BA bitmap. In some embodiments, the BA frame includes a BA ending sequence number (ESN) determinative of a size of the variable size BA bitmap. In some embodiments, the BA frame includes a BA starting sequence control (SSC), wherein the BA SSC and the BA ESN define the size of the variable size BA bitmap. In some embodiments, generating the BA frame includes determining whether the BA ESN is equal to a number of octets transmitted from the device beginning with the BA SSC. In some embodiments, the BA frame includes a third BA indication associated with a third channel of the wireless network and a fourth BA indication associated with a fourth channel of the wireless network.

In a seventh example embodiment, there is discloses a device having means for setting, in a first field of a BA frame, a first block acknowledgment (BA) indication associated with a first channel. The BA frame includes the first field for the first block acknowledgment indication associated with the first channel and a second field for a second block acknowledgment indication associated with the second channel. The device includes means for setting, in a BA ending sequence number (ESN) field of the BA frame, a BA ESN determinative of a size of a variable size BA bitmap of the BA frame and means for directing the transmission, over a wireless network comprising the first channel and the second channel, the block acknowledgement frame from a first computing device.

In some embodiments, the device includes means for setting a BA starting sequence control (SSC) using a BA SSC field of the block acknowledgment frame, wherein the BA SSC and the BA ending sequence number define the size of the variable size BA bitmap. In some embodiments, the device includes means for determining that the BA ESN does not equal a total number of octets transmitted starting from a BA SSC and means for setting an acknowledgment indication in an acknowledgment field and a traffic identifier (TID) value in a TID field of the BA frame. In some embodiments, the device includes means for determining that the BA ESN equals a total number of octets transmitted starting from a BA SSC, such that the BA frame transmitted from the first computing device does not include a BA bitmap. In some embodiments, the device includes means for setting a value in a multi-traffic identifier indication field, a value in a compressed bitmap indication field, and a value in a Groupcast with Retries (GCR) indication field to indicate a type of the block acknowledgement frame. In some embodiments, the BA frame includes a third field for a third block acknowledgment indication for a third channel and a fourth field for a fourth block acknowledgment indication for a fourth channel.

In an eighth example embodiment there is disclosed a device having means for obtaining first frames transmitted over a first channel of a wireless network and means for generating, in response to receiving the first frames, a block acknowledgement (BA) frame. The BA frame includes a first BA indication associated with the first channel and a second BA indication associated with a second channel of the wireless network. The device further includes means for directing the transmission, over a wireless network, the BA frame from the device.

1. A non-transitory computer-readable medium storing computer-executable instructions that, when executed by a processor, cause the processor to perform operations comprising:
setting, in a first field of a BA frame, a first block acknowledgment (BA) indication associated with a first channel, the BA frame comprising the first field for the first block acknowledgment indication associated with the first channel and a second field for a second block acknowledgment indication associated with the second channel;
setting, in a BA ending sequence number (ESN) field of the BA frame, a BA ESN determinative of a size of a variable size BA bitmap of the BA frame; and
directing the transmission, over a wireless network comprising the first channel and the second channel, of the block acknowledgement frame from a computing device.

2. The non-transitory computer-readable medium of claim 1, the operations further comprising:
setting a BA starting sequence control (SSC) using a BA SSC field of the BA frame, wherein the BA SSC and the BA ending sequence number (ESN) define the size of the variable size BA bitmap.

3. The non-transitory computer-readable medium of claim 1, wherein the first channel comprises a first 20 MHz channel and the second channel comprises a second 20 MHz channel allocated after the first 20 MHz channel.

4. The non-transitory computer-readable medium of claim 3, wherein the first 20 MHz channel comprises a plurality of sub-channels and the second 20 Mhz channel comprises a plurality of sub-channels.

5. The non-transitory computer-readable medium of claim 1, the operations further comprising:
determining that the BA ESN does not equal a total number of octets transmitted starting from a BA SSC; and
setting an acknowledgment indication in an acknowledgment field and a traffic identifier (TID) value in a TID field of the BA frame.

6. The non-transitory computer-readable medium of claim 1, the operations further comprising:
determining that the BA ESN equals a total number of octets transmitted starting from a BA SSC,
wherein the block acknowledgement frame transmitted from the computing device does not include a BA bitmap.

7. The non-transitory computer-readable medium of claim 1, the operations further comprising:
setting a value in a multi-traffic identifier indication field, a value in a compressed bitmap indication field, and a value in a Groupcast with Retries (GCR) indication field to indicate a type of the block acknowledgement frame.

8. The non-transitory computer-readable medium of claim 1, the block acknowledgement frame comprising a third field for a third block acknowledgment indication for a third channel and a fourth field for a fourth block acknowledgment indication for a fourth channel.

9. A device, comprising:
one or more processors having circuitry including logic to:
set, in a first field of a BA frame, a first block acknowledgment (BA) indication associated with a first channel, the BA frame comprising the first field for the first block acknowledgment indication associated with the first channel and a second field for a second block acknowledgment indication associated with the second channel;
set, in a BA ending sequence number (ESN) field of the BA frame, a BA ESN determinative of a size of a variable size BA bitmap of the BA frame; and
direct the transmission, over a wireless network, of the block acknowledgement frame from the device.

10. The device of claim 9, the one or more processors having circuitry including logic to:
set a BA starting sequence control (SSC) using a BA SSC field of the BA frame, wherein the BA SSC and the BA ending sequence number define the size of the variable size BA bitmap.

11. The device of claim 9, wherein the first channel comprises a first 20 MHz channel and the second channel comprises a second 20 MHz channel allocated after the first 20 MHz channel.

12. The device of claim 9, the one or more processors having circuitry including logic to:
determine that the BA ESN does not equal a total number of octets transmitted starting from a BA SSC; and
set an acknowledgment indication in an acknowledgment field and a traffic identifier (TID) value in a TID field of the BA frame.

13. The device of claim 9, the one or more processors having circuitry including logic to:
set a value in a multi-traffic identifier indication field, a value in a compressed bitmap indication field, and a value in a Groupcast with Retries (GCR) indication field to indicate a type of the block acknowledgement frame.

14. The device of claim 9, the block acknowledgement frame comprising a third field for a third block acknowledgment indication for a third channel and a fourth field for a fourth block acknowledgment indication for a fourth channel.

15. A device, comprising:
one or more processors having circuitry including logic to:
obtain first frames transmitted over a first channel of a wireless network;
generate, in response to obtaining the first frames, a block acknowledgement (BA) frame, the BA frame comprising:
a first BA indication associated with the first channel; and
a second BA indication associated with a second channel of the wireless network; and
direct the transmission, over a wireless network, of the BA frame from the device.

16. The device of claim 15, the BA frame comprising a variable size BA bitmap.

17. The device of claim 16, the BA frame comprising a BA ending sequence number (ESN) determinative of a size of the variable size BA bitmap.

18. The device of claim 17, the BA frame comprising a BA starting sequence control (SSC), wherein the BA SSC and the BA ESN define the size of the variable size BA bitmap.

19. The device of claim 15, wherein generating the BA frame comprises determining whether the BA ESN is equal to a number of octets transmitted from the device beginning with the BA SSC.

20. The device of claim 15, the BA frame comprising a third BA indication associated with a third channel of the wireless network and a fourth BA indication associated with a fourth channel of the wireless network.
